(19) United States
(12) Patent Application Publication
(10) Pub. No.: US 2024/0185322 A1
(43) Pub. Date: Jun. 6, 2024

(54) WEARABLE DEVICE RECOMMENDATIONS BY ARTIFICIAL INTELLIGENCE

(71) Applicant: INTERNATIONAL BUSINESS MACHINES CORPORATION, Armonk, NY (US)

(72) Inventors: Martin G. Keen, Cary, NC (US); Makenzie Manna, Poughkeepsie, NY (US); Ivan Deleuze, Montpellier (FR); Victor Tardieu, Montpellier (FR)

(21) Appl. No.: 18/060,773

(22) Filed: Dec. 1, 2022

(51) Int. Cl. G06Q 30/0601

(52) U.S. Cl. CPC G06Q 30/0631

(57) ABSTRACT

Artificial intelligence (AI) is used to generate contextual wearable device recommendations to a user. Data is received at a computer that characterizes a user's environment, wherein the user environment includes location data. A prediction is made of user activity. A prediction is made, with a computer, of user activity from the location data. Predicting the user activity includes artificial intelligence analyzing the location data for comparison with activities from historical activity data for the user. A list of wearable devices that are present on the user are characterized by sensors for capability. At least one of the wearable devices is matched to the user activity. By employing artificial intelligence the computer wearable devices are matched by capability of their sensor to the user activity

### BACKGROUND

The present invention generally relates to wearable smart devices, and more particularly to matching wearable smart devices to activities.

Personal wearable smart devices contain a collection of sensors and communication technologies. Smart devices are interactive electronic gadgets that understand simple commands sent by users and help in daily activities. In some examples, a smart device is an electronic device, that is generally connected to other devices or networks via different wireless protocols that can operate to some extent interactively and autonomously. Some of the most commonly used smart devices are smartphones, tablets, phablets, smartwatches, smart glasses and other personal electronics.

### SUMMARY

In accordance with a first aspect of the present invention, a computer implemented method is provided for artificial intelligence (AI) to generate contextual wearable device recommendations to a user. In one embodiment, the method includes receiving data, at a computer, characterizing a user's environment, wherein the user environment includes location data. In some embodiments, the computer implemented method can also predict, with a computer, a user activity from the location data. Predicting the user activity can include artificial intelligence analyzing the location data for comparison with activities from historical activity data for the user. The method can also receive, at the computer, a list of wearable devices that are present on the user. The user's wearable devices are characterized by sensors for capability. The method may also include matching, using the computer, at least one of the wearable devices to the user activity. By employing artificial intelligence the computer wearable devices are matched by capability of their sensor to the user activity. In some embodiments, the method also includes sending, using the computer, a recommendation identifying the at least one wearable devices to the user based on the matching.

In another aspect, the present disclosure describes a system for artificial intelligence (AI) to generate contextual wearable device recommendations to a user. The system can include a hardware processor; and a memory that stores a computer program product. The computer program product when executed by the hardware processor, causes the hardware processor to receive data characterizing a user's environment, wherein the user environment includes location data; and predict user activity from the location data. In some embodiments, predicting the user activity comprises artificial intelligence analyzing the location data for comparison with activities from historical activity data for the user. The computer program product when executed by the hardware processor, can also cause the hardware processor to receive data characterizing a user's environment, and receive a list of wearable devices that are present on the user. The user's wearable devices are characterized by sensors for capability. The system can also match at least one of the wearable devices to the user activity. By employing artificial intelligence the computer wearable devices are matched by capability of their sensor to the user activity. In some embodiments, the system can also send a recommendation identifying the at least one wearable devices to the user based on the matching.

In yet another aspect, a computer program product is described for generating contextual wearable device recommendations to a user. The computer program product can include a computer readable storage medium having computer readable program code embodied therewith. The program instructions executable by a processor to cause the processor to receive, using the hardware processor, data characterizing a user's environment, wherein the user environment includes location data. The program instructions can also predict, using the hardware processor, user activity from the location data, wherein predicting the user activity comprises artificial intelligence analyzing the location data for comparison with activities from historical activity data for the user. The program instructions can also receive, using the hardware processor, a list of wearable devices that are present on the user, wherein the user's wearable devices are characterized by sensors for capability. In some embodiments, the program instructions can also match, using the hardware processor, at least one of the wearable devices to the user activity, wherein by employing artificial intelligence the computer wearable devices are matched by capability of their sensor to the user activity. In some embodiments, the program instructions can also send, using the hardware processor, a recommendation identifying the at least one wearable devices to the user based on the matching.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is an illustration of an environment illustrating an application for the methods, systems and computer program products that provide for contextual wearable device recommendations, in accordance with one embodiment of the present disclosure.

FIG. 2 illustrates one embodiment of a flow chart for a computer implemented method for contextual wearable device recommendations, in accordance with one embodiment of the present disclosure.

FIG. 3 is a flow chart/block diagram illustrating a system for providing contextual wearable device recommendations, in accordance with one embodiment of the present disclosure.

FIG. 4 is a generalized diagram of a neural network, in accordance with one embodiment of the present disclosure.

FIG. 5 is a block diagram illustrating a system that can incorporate the system for contextual wearable device recommendations that are depicted in FIG. 2, in accordance with one embodiment of the present disclosure.

FIG. 6 depicts a computing environment according to an embodiment of the present disclosure.

### DETAILED DESCRIPTION

In some embodiments, the methods, systems and computer program products that are described herein can provide a method for contextual wearable device recommendations. Personal wearable smart devices contain a collection of sensors and communication technologies. Examples of smart devices can include smart watches, fitness trackers, electrocardiogram (ECG), blood pressure monitors, Bio sensors and combinations thereof. The aforementioned types of devices may be composed of devices having similar functionality. Therefore, the different types of smart devices could be employed in various different utilities. For example, a smart watch may can play the role of fitness tracker, because it can measure steps taken; a heat rate monitor; and EKG monitor. Additionally, most modern phones provide accelerators and gyroscope sensors to determine movement.

The systems, methods and computer program products that are described herein can recommend to a user which of their wearable smart devices they should wear for optimal measurement based on their forecasted activity. In some embodiments, the systems of the present disclosure can forecast an imminent user activity based upon observed temporal activity observations. The system can further derive the optimal wearable device selection to record the user activated based upon optimal sensor measurement and optimal communication requirements. The system can further include alerting a user to a wearable device recommendation if the user is not already equipped with the optimal wearable device.

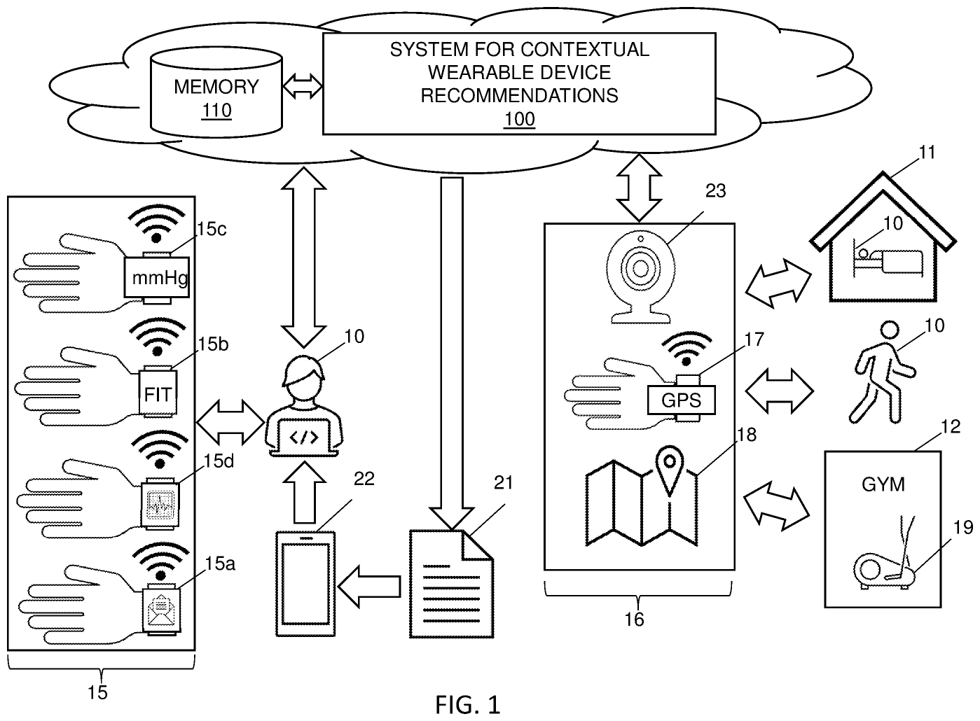

Referring now to the drawings in which like numerals represent the same or similar elements, the methods, systems and computer program products for providing a simulated critical path based proactive optimization are now described in greater detail with reference to FIGS. 1-6.

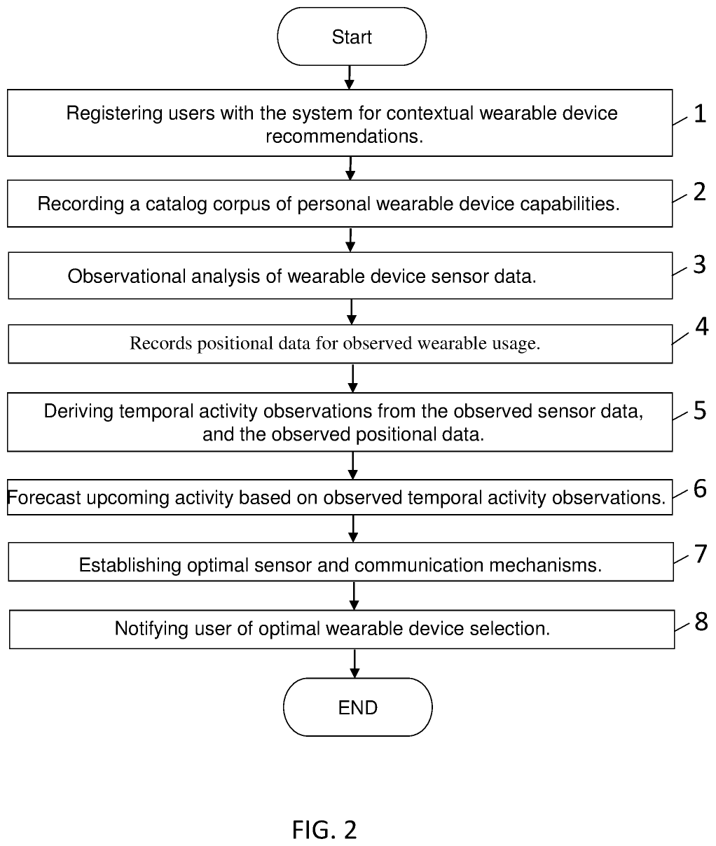

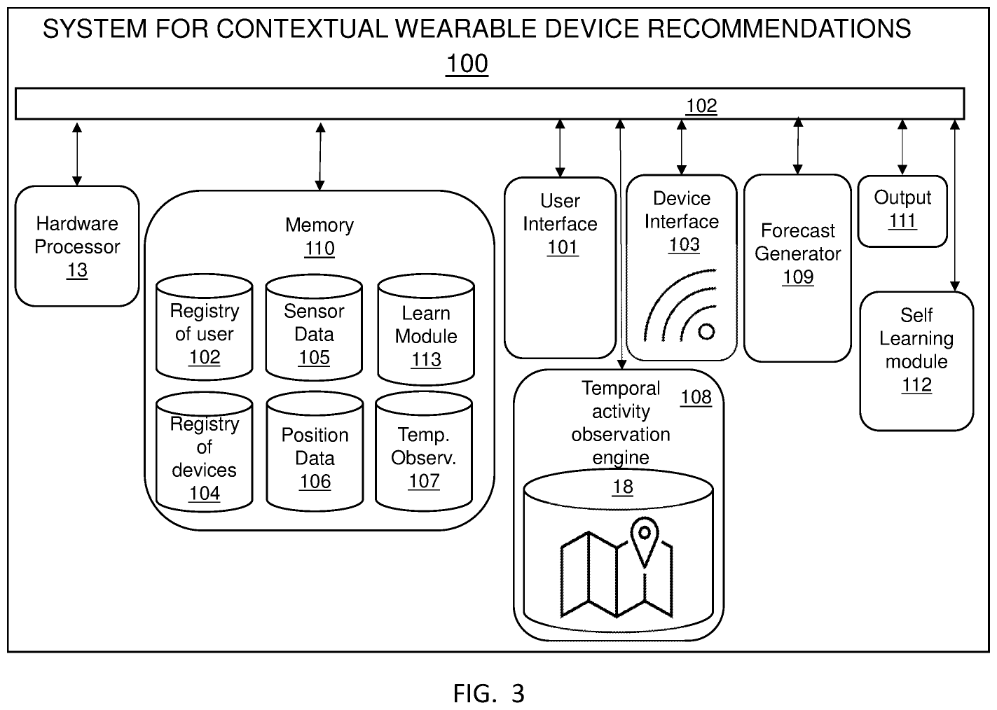

FIG. 1 is an illustration of an environment illustrating an application for the methods, systems and computer program products that provide for contextual wearable device recommendations. FIG. 2 illustrates one embodiment of a flow chart for a computer implemented method that provides contextual wearable device recommendations, in accordance with one embodiment of the present disclosure. FIG. 3 is a block diagram illustrating a system that provides contextual wearable device recommendations.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 illustrates one embodiment of an environment illustrating an application for the methods, systems and computer program products that provide for contextual wearable device recommendations. In this situation, the user 10 has already registered with a computer implemented system, e.g., system for contextual wearable device recommendations 100, that keeps an inventory of what types of wearable smart devices 15 are on the user 10, and what types of sensors are present in the wearable smart devices. The computer implemented system, e.g., system for contextual wearable device recommendations 100, also has access to data indicating a history of activities the user has performed. This information can all be saved in memory 110, which may be cloud type storage. The system for contextual wearable device recommendations 100 can also be cloud based 50.

In some embodiments, the system for contextual wearable device recommendations 100 is cloud based. A cloud based system, often known as cloud computing, is a broad term for anything that involves the delivery of hosted services via the internet.

Additionally, from temporal observations, the computer implemented system can predict an activity that the user 10 is going to perform. Further, from the list of wearable smart devices the user has access to, e.g., is registered with on the system, the computer implemented system can alert the user to what devices the user will want to wear when performing the predicted activity that the user is about to perform.

For example, the user 10 may be on a business trip, and may be at a hotel 11. While at the hotel, the user 10 may be about to head to the hotel gym 12, as depicted in FIG. 1. The user 10 may have already registered with the system for contextual wearable device recommendations 100. In some examples, because of the registration process, the system for contextual wearable device recommendations 100 has an account associated with the user 10 that includes within the memory of the system the list of wearable smart devices 15 that the user 10 has access too. For example, the user 15 may have on their person, or may have access to, a smart watch 15a, a fitness tracker 15b, as well as bio sensors 15c, 15d. Examples of biosensors that the user 10 may have access to are a blood pressure monitor 15c and an electrocardiogram (ECG) 15d, blood pressure monitors, Bio sensors and combinations thereof. As noted, each of the wearable smart devices may be composed of devices having similar functionality. Therefore, the different types of smart devices could be employed in various different utilities. For example, a smart watch can play the role of fitness tracker, because it can measure steps taken; a heat rate monitor; and EKG monitor.

Still referring to FIG. 1, when the user 10 is at the hotel, the system 100 can determine from imminent user activity based upon observed temporal activity observations. For example, the system 100 can have historical data on user activity, which can be stored in the memory 110 of the system 100. For example, the user 10 may have a history of use for the smart devices for use with exercise activities. That information may be recorded by the system 100, stored in memory 110, and correlated to a user account associated with the user 10.

Referring to FIG. 1, the system 100 can determine the location of the user 10. The system 10 may be in communication with position rendering technologies 16. For example, the user 10 may be using one or more devices, such as wearable smart devices, that includes GPS tracking 17. The GPS tracking device 17 can be used to determine the location of the data. In the example depicted in FIG. 1, the system 100 can determine from the GPS tracking device 17, that the user 10 is at a hotel.

Further, the system 100 can also have access to geospatial technology. The term “geospatial” denotes any data that is indicated by or related to a geographic location. Geospatial technology collects and analyzes the geospatial data. For example, geospatial technology can use geometric shapes to show the location and shape of geographic features. Points, lines and polygons can represent things like cities, roads and waterways. Vector data is scalable, has small file sizes and ideal for depicting boundaries. The geospatial technology can also employ raster data, which represents data through a digital image such a scanned map or photograph. It also includes aerial and satellite imagery. Raster data uses a cell-based format called stair stepping to record data as pixels or grids with an image. Spatial analysis depends heavily on raster datasets.

The system for contextual wearable device recommendations 100 utilizes the observed sensor data and observed positional data to derive temporal activity observations. The system for contextual wearable device recommendations 100 utilizes mapping software 18 to derive geospatial information for a given location. For example, the information may reveal the user's location is a gym and that their activity correlates to running on an elliptical trainer 19.

In the example illustrated in FIG. 1, the system for contextual wearable device recommendations 100 can forecast that the user will ride the elliptical trainer 19, based upon historical analysis of her observed exercise behavior.

The user 10 may be wearing their smart watch 15a. Although the smart watch 15a, may track exercise activity on the elliptical trainer 19, the model of elliptical trainer 19 that is present in the gym 12 of the hotel 11 may support software that monitors heart rate using a different type of device. The system for contextual wearable device recommendations 100 conducts an analysis of the user's wearable devices 15. For example, the analysis of the wearable devices 15 can illustrate that the user's smart watch 15a does not support the aforementioned heart rate monitor. However, same analysis can determine that the user 10 also has access to other devices, such as a fitness tracker 15b or ECG tracker 15d, that do support the heart rate monitor application being used by the elliptical trainer 19 are within the control of the user 10. The analysis may be configured as a report 21.

The system can further derive the optimal wearable device selection to record the user activated based upon optimal sensor measurement and optimal communication requirements. The system can further include alerting a user to a wearable device recommendation if the user is not already equipped with the optimal wearable device. For example, the contextual wearable device recommendations 100 sends a notification to the user 10, e.g., by sending a communication to her phone 22, in which the communication may be the report 21 identifying which devices, i.e., wearable smart devices 15, the user 10 should use that day. For example, the report 21 may indicate to the user 10 before they leave to go to the gym 12 that the user 10 should wear at least one of the fitness tracker 15b or ECG tracker 15d if they would like to use the elliptical trainer 19, i.e., the predicted activity. In some instances, the system 100 can also configure the selected devices to work with the application of the predicted activity, which can include an automatic download of an application for working with the equipment of the predicted activity, e.g., the elliptical trainer.

FIG. 2 illustrates one embodiment of a flow chart for a computer implemented method for contextual wearable device recommendations, in accordance with one embodiment of the present disclosure.

In some embodiments, the method may begin at block 1, which can include registering users 10 with the system for contextual wearable device recommendations 100. The method may begin with in response to receiving permission from a user 10 for data collection, and registering users 10 with the system for contextual wearable device recommendations 100. To the extent implementations of the invention collect, store, or employ personal information provided by, or obtained from, individuals (for example, current locations of drivers, historical records of drivers, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

FIG. 3 is a flow chart/block diagram illustrating a system for providing contextual wearable device recommendations, in accordance with one embodiment of the present disclosure. The system 100 may include at least one user interface 101 through which the user can register with the system. The registry 102 includes at least one module of memory 110, such as hardware memory, for account data corresponding to the user. As noted, the system for contextual wearable device recommendations 100 may be cloud based. Further, the user 10 may register with the system through the internet, e.g., world wide web, using any computing device having access to the internet, e.g., desktop computer, laptop computer, mobile computing device, smart phone, tablet etc. The system 100 may provide at least one web based page having fields for data input through which the user 10 may register.

Referring back to FIG. 2, the computer implemented method may continue with block 2. Block 2 includes recording a catalog corpus of personal wearable device capabilities. As noted, the user 10 opts into the system 100, in which thereafter, the system is enabled to communicate with the wearable smart devices 15 of the user 10. Referring to FIG. 3, the system 100 includes a device interface 103. The device interface 103 receives information, e.g., data, from the separate wearable smart devices 15 regarding their capabilities. The device interface 103 may collect information across the internet, however, in some instances the device interface 103 may include a cellular connection or radio type connection. It is not intended that the device interface 103 of the system 100 be limited to internet type communications. Still referring to FIG. 3, the catalog corpus of personal wearable device capabilities may be stored in a module of the memory 110 characterized as a registry of user devices 103. The registry of user devices 103 includes stored entries for the wearable smart devices 15 of each user, and the capabilities of each wearable smart device 15 for each user.

In some embodiments, each of the wearable devices 15 provides information to the system 100 regard the current capabilities for the devices. As illustrated in FIG. 1, some examples of wearable smart devices include a smart watch 15a, a fitness tracker 15b, blood pressure monitor 15c, an electrocardiogram (ECG) 15d and combinations thereof.

Referring to FIGS. 1-3, each wearable smart device 15 may have at least two categories of characterization for each type of device. For example, the two categories of characterization for the wearable smart devices 15 can include sensor capabilities, and communication capabilities. In some examples, sensor capabilities for the smart wearable devices 15 can include the sensor's ability to record information related to movement and position including sensors such as magnetometer, accelerometer, gyroscope, EKG, heart rate, blood pressure, and combinations thereof. In some embodiments, communication capabilities include communications supported by the wearable devices, such as Bluetooth, WiFi V6, ultrasound, Ant+, and so forth.

The capabilities of the smart wearable devices 15 for the catalog corpus is stored in the device registry 104 of the memory 110. The catalog corpus is continued to be updated over time as the user adds or removes wearable devices to the corpus and as sensor and communication capabilities changes over time. For example, features which are added or removed through firmware updates may be updated to the device registry 104.

Referring to FIG. 2, the computer implemented method can further include observational analysis of wearable smart device sensor data at block 3. The system for contextual wearable device recommendations 100 records sensor recordings for all wearable devices 15 that are part of the catalog corpus, e.g., stored in the device registry 104. For example, all wearable sensor data collection is recorded for all sensors on all active wearable devices. In one example, the steps a user takes, their heart rate readings, their skin temperature and so forth may be recorded from the user 10 by the wearable smart devices 15.

Referring to FIG. 3, the system for contextual wearable device recommendations 100 can receive the sensor data through the sensor interface 103, and can store the aforementioned sensor data in cloud based memory 110 in a module identified as sensor data 105. This may be hardware memory.

Referring to FIG. 2, in some embodiments, the system 100 records positional data for observed wearable usage at block 4. As noted, the wearable smart devices may include GPS capabilities 17. In some embodiments, positional data can include both data on user position, and data corresponding to the time the user is at a location. Location (Position) is established by a wearable smart device 15 in the corpus. Note that position can be derived if only one wearable device in the corpus supports position tracking. For example, if a user has two devices, such as a heart rate monitor 15d having no mechanism for positional tracking and a smart phone 15a that does include positional tracking, while a heart rate monitor may not know it's location, an accompanying smart phone can report its position when carried on the user's person and therefore can also derive the position of that heart rate monitor. The time a user is at a location (e.g., time of day) is the date and time recordings correlated to position, as established by location. The observed sensor data collected by the wearable smart devices is correlated with the observed positional data.

Referring to FIG. 3, the system for contextual wearable device recommendations 100 can receive the positional data through the sensor interface 103, and can store the aforementioned positional data in cloud based memory 110 in a module identified as positional data 106. This may be hardware memory.

Referring to FIG. 2, the computer implemented method may continue to deriving temporal activity observations at block 5. More specifically, in one embodiment, the computer implemented method derives temporal activity observations from the observed sensor data, and the observed positional data. In some embodiments, the invention system utilizes mapping software 18 to derive geospatial information for a given location. For example, the computer implemented methods can derive that sensor data relates to an area. For example, from the mapping software 18, the positional data may relate to a park. In the above example, in which the mapping software identifies a park, the system for contextual wearable device recommendations 100 can employ sensors, e.g., the sensors within the smart wearable devices 15 or sensors, such as cameras 23, can be used to provide data that relates to elements within the park, e.g., such as trails. In some examples, positional data 106 over time reveals that the user is on a trial, and activity data 105 correlates to hiking on the trail. The activity data, could be steps or heartrate, which can be measured from the wearable smart devices 15. In another example, the mapping software 18 when employed with the positional data 106 may reveal that the user's location is a gym 12, as illustrated in FIG. 1, and the user's activity from the activity data 105 illustrates that the user 10 is running on a treadmill. These are only some examples of how the location data 106 and the activity data 105, which can be provided by the wearable smart devices 15, can provide temporal activity observations at block 5 of the computer implemented method in FIG. 1.

Referring to FIG. 3, the temporal activity observations are derived using a temporal activity observation engine 108 in the system for contextual wearable device recommendations 100. The activity observation engine 108 has access to the sensor readings and positional data readings received from the device interface 103, which can be stored in the location data 106 and the activity data 105 modules of the memory 110. The temporal activity observation engine 108 also includes the mapping software 18.

First, the activity observation engine 108 can associate the positional data 106 and activity data 105 with the mapping software to indicate that the user 10 uses specific wearable devices 15 when performing activities associated with the location. This can be provided through artificial intelligence. For example, an artificial neural network (ANN) may be suitable for this purpose of providing the activity observation engine 108.

An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

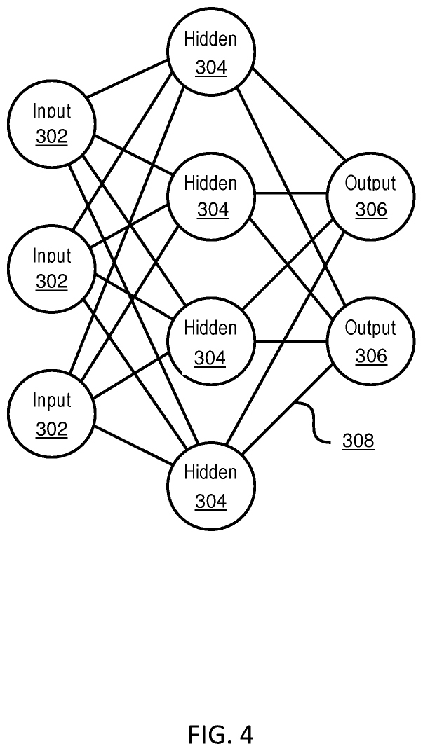

Referring now to FIG. 4, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 402 that provide information to one or more “hidden” neurons 404. Connections 408 between the input neurons 402 and hidden neurons 404 are weighted, and these weighted inputs are then processed by the hidden neurons 404 according to some function in the hidden neurons 404. There can be any number of layers of hidden neurons 404, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 406 accepts and processes weighted input from the last set of hidden neurons 404.

This represents a “feed-forward” computation, where information propagates from input neurons 402 to the output neurons 406. Upon completion of a feed-forward computation, the output is compared to a desired output available from training data. The error relative to the training data is then processed in “backpropagation” computation, where the hidden neurons 404 and input neurons 402 receive information regarding the error propagating backward from the output neurons 406. Once the backward error propagation has been completed, weight updates are performed, with the weighted connections 408 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. The training data can be provided by the data that is stored in the historical training database, e.g., the data that is stored in the activity data 105, positional data 106 and temporal observation module 107. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 408 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 408 may be implemented as resistive processing units (RPUs), generating a predictable current output when an input voltage is applied in accordance with a settable resistance.

In some embodiments, the weights 408 may be used to indicate what activities are to be performed corresponding to location of the user 10, as well as what wearable smart devices 15 are to be employed by the user 10 when performing the activity at the location. As noted each time, a user 10 performs an activity at a location that is correlated to the wearable smart devices 15 of the user, that information may be stored in the temporal activity observation module (Temp. Observ. 107) of the memory 110 of the system.

The temporal activity observation engine 108 can further analyze a user's predicted further activities with respect to the user's wearables for compatibility to the predicted further activities. In some embodiments, the method can recommend, using the computer one or more wearables to the user based on the analysis.

Temporal activity observations are recorded over time and stored in the corpus. For example, referring to FIG. 3, the temporal activity observations are stored in the temporal activity observation module (Temp. Observ. 107) of the memory 110 of the system.

In some embodiments, the invention system utilizes this temporal activity observation corpus to forecast upcoming activity based upon observed temporal activity observations at block 6 of the computer implemented method illustrated in FIG. 2. In some embodiments, forecasting utilizes a collection of current location and wearable sensor data and utilizing this information into a clustering of observed temporal activity observations. In some embodiments, the temporal activity observation engine 108 collects the activity data 105, e.g., wearable sensor data, and the current location, e.g., positional data, via the wearable device interface 103. The forecast technique considers the collected data of the temporal activity in comparison to at least the historical information, e.g., the previously stored temporal activity observations that can be stored in the temporal activity observation module (Temp. Observ. 107) of the memory 110 of the system.

In some embodiments, the forecasting techniques to derive imminent activity based upon observed historical information can include at least one of regression clustering and K-nearest neighbor analysis. “Regression clustering” is clustering of the dataset into subsets each with a simpler distribution matching. For example, regression clustering reveals the user is currently in a gym, and prior visits to a gym result in the user utilizing an exercise bike. “K-nearest neighbor” analysis is a non-parametric classification to derive imminent activity where insufficient clustering exists. For example, when the user is found in a park, the system derives expected activity even if the user has never visited the location before simply from similar attributes in a kNN cluster.

The regression clustering and K-nearest neighbor analysis may include instructions stored in the memory 110, wherein the calculations can be performed using the hardware processor 13.

The output from the temporal activity observation engine 108 depicted in FIG. 3 for providing block 6 of the computer implemented method illustrated in FIG. 2 can be a forecasted upcoming activity with a confidence level indicating the strength of the forecast.

Still referring to FIG. 2, in some embodiments, the method may further include establishing optimal sensor and communication mechanisms at block 7. The system for contextual wearable device recommendations 100 can establish an optimal sensor and communication mechanisms. In some embodiments, the system 100 depicted in FIG. 3 includes a forecast generator 109 that can derive the optimal sensors 15 required to accurately record the forecast upcoming activity. In many cases multiple wearable devices will be able to record an activity and the system 100 can derive which are most suited for a task. For example, both a smart phone 22 and smart watch 15a can detect movement through a gyroscope and accelerometer, but if the user is forecasted to perform weight training a smart watch 15a worn on a wrist will provide more accurate movement data than a mobile phone stored in a pocket.

In some embodiments, the forecast generator 109 can employ the history of wearable smart devices, e.g., that is stored in the temporal activity observation module (Temp. Observ. 107) of the memory 110 of the system) in combination with the types of devices that are registered for use with the user 10 that is saved in the registry of users 102 and registry of devices 104 with artificial intelligence to determine the appropriate combination of smart wearable devices 15 for the forecasted upcoming activity based upon observed temporal activity observations that were provided at block 6 of the computer implemented method illustrated in FIG. 2.

The artificial intelligence for suggesting establishing optimal sensor and communication mechanisms at block 7 of the computer implemented method illustrated in FIG. 2 may include a neural network, as described above with reference to FIG. 4. As described above, the forecast generator 109 can employ the history of wearable smart devices, e.g., that is stored in the temporal activity observation module (Temp. Observ. 107) of the memory 110 of the system) in combination with the types of devices that are registered for use with the user 10 that is saved in the registry of users 102 and registry of devices 104.

In some embodiments, forecast generator 109 derives communication mechanisms needed to interact between the wearable devices and other devices. As noted, the system 100 keeps a record of the sensors and capabilities of the wearable smart devices in the registry of devices 104 that is stored in the memory 110. Further, the system 100 can also forecast activities at locations that the user 10 is going to perform. For example, of the system for contextual wearable device recommendations 100 has derived the user 20 will utilize an exercise bike, the system can retrieve supported communications of the bike and the communication capabilities of the user's wearable devices looking for optimal methods. The system for contextual wearable device recommendations 100 can communicate with the apparatus for the proposed activity through the device interface 103. The apparatus for the predicted activity may be connected to the internet via WiFi, by cellular connection, or the apparatus may connect to a network using RF connections. The communication mechanism of the apparatus may have a suitable receiver at the system for contextual wearable device recommendations 100, e.g., through the device interface 103.

The data from the temporal activity observation module (Temp. Observ. 107) of the memory 110 of the system), the devices associated with the user 10 from the registry of users 102, and the capabilities of the smart wearable devices from the registry of devices 104 can be used to train the artificial intelligence, e.g., neural network, to make optimal sensor and communication mechanisms suggestions in response to the forecast upcoming activity based upon observed temporal activity observations at block 6 of the computer implemented method illustrated in FIG. 2.

It is noted that the neural network is only one example of the type of artificial intelligence that can be employed by the forecast generator 109. It is noted that any type of machine learning is applicable. Machine learning (ML) employs statistical techniques to give computer systems the ability to “learn” (e.g., progressively improve performance on a specific task) with data, without being explicitly programmed. The machine learning method that can be used to suggestion mitigating steps in response to critical paths can employ decision tree learning, association rule learning, artificial neural networks, deep learning, inductive logic programming, support vector machines, clustering analysis, bayesian networks, reinforcement learning, representation learning, similarity and metric learning, sparse dictionary learning, genetic algorithms, rule-based machine learning, learning classifier systems, and combinations thereof.

In some embodiments, the forecast generator 109 can recommend optimal sensor and communication mechanisms at block 7 of the computer implemented method illustrated in FIG. 2 using a machine learning algorithm that can be selected from the group consisting of: Almeida-Pineda recurrent backpropagation, ALOPEX, backpropagation, bootstrap aggregating, CN2 algorithm, constructing skill trees, dehaene-changeux model, diffusion map, dominance-based rough set approach, dynamic time warping, error-driven learning, evolutionary multimodal optimization, expectation-maximization algorithm, fastICA, forward-backward algorithm, geneRec, genetic algorithm for rule set production, growing self-organizing map, HEXQ, hyper basis function network, IDistance, K-nearest neighbors algorithm, kernel methods for vector output, kernel principal component analysis, leabra, Linde-Buzo-Gray algorithm, local outlier factor, logic learning machine, LogitBoost, manifold alignment, minimum redundancy feature selection, mixture of experts, multiple kernel learning, non-negative matrix factorization, online machine learning, out-of-bag error, prefrontal cortex basal ganglia working memory, PVLV, Q-learning, quadratic unconstrained binary optimization, query-level feature, quickprop, radial basis function network, randomized weighted majority algorithm, reinforcement learning, repeated incremental pruning to produce error reduction (RIPPER), Rprop, rule-based machine learning, skill chaining, sparse PCA, state-action-reward-state-action, stochastic gradient descent, structured kNN, T-distributed stochastic neighbor embedding, temporal difference learning, wake-sleep algorithm, weighted majority algorithm (machine learning) and combinations thereof.

It is noted that the above examples of algorithms used for machine learning (ML)/artificial intelligence have been provided for illustrative purposes only.

Referring to FIG. 2, the method an continue with making a notification of optimal wearable device selection and self-learning of forecasts. As illustrated in FIG. 1, in one example, the notification may be report 21, which can be sent to the email of the user's smart phone 22. It is noted that electronic mail is only one example for how the message is sent to the user 10. For example, in other embodiments, the message may be sent via a form of text message, e.g., short message service (SMS). Referring to FIG. 3, the system 100 may have an output 100 for sending the report 21 to the user 10 via the internet, e.g., sending the report via electronic mail to the user.

In some embodiments, with the optimal sensor and communication mechanisms determined, the system for contextual wearable device recommendations 100 can then compare the optimal sensors to the wearable devices 15 being worn by a user 10. The system 100 keeps in memory 110, e.g., in the registry of users 102 and registry of devices 104, a list of devices 15 that the user 10 has access to, e.g., can be wearing. Further, through the device interface 103, the system 100 can also determine the devices being actively worn by the user 10. In some embodiments, if the user 10 is not equipped with the optimal wearable device(s) (optimal from a sensor and communication perspective), the user 10 can receive an alert from the system 100 with a wearable device recommendation stating: (1) the user's derived activity (from block 5 of FIG. 2); (2) the wearable device that is optimal to this activity; and (3) justification for the selection.

The user engages in the activity wearing the optimal wearable device. In some instances, the system 100 can also configure the user's device 15 for the user's derived activity. This can include automatically changing settings of the user's device 15 to correspond with the capabilities of equipment, e.g., an app on exercise equipment, for the derived activity. In some instances, the system 100 can automatically install software onto the user's device 15. This can be achieved through the device interface 103 of the system.

In some embodiments, a self-learning module 112 analyzes forecasted activity with wearable usage and compares this with actual observed activity and wearable activity. This resulting in a forecast scoring mechanism which is used to provide better forecasts for future activities. The results of the self-learning module 112 may be stored in the memory 110 of the system 100, e.g., the self learn module 113 of the memory.

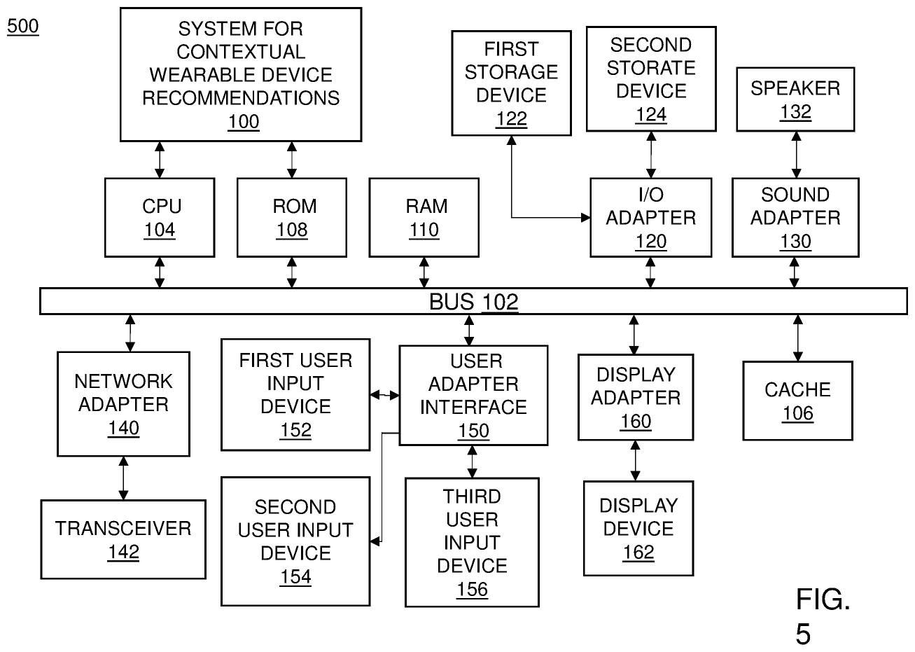

Referring to FIGS. 3 and 5, in some embodiments, the components of the system 100 are interconnected by a bus 102. The bus 102 may also be in communication with at least one hardware processor, in which the hardware processor 12 may function with the other elements depicted in FIGS. 3 and 5 to provide the functions described above.

FIG. 5 further illustrates a processing system 500 that can include the critical path optimization system 200 described with reference to FIGS. 1-4. The exemplary processing system 500 to which the present invention may be applied is shown in accordance with one embodiment. The processing system 500 includes at least one processor (CPU) 104 operatively coupled to other components via a system bus 102. The system bus 102 may be in communication with the system for critical path based optimization. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 that provides for provenance based identification of policy deviations in cloud environments can be integrated into the processing system 400 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 500 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The present invention may be a system, a method, and/or a computer program product at any possible technical detail level of integration. For example, in some embodiments, a computer program product is provided for artificial intelligence (AI) to generate contextual wearable device recommendations to a user. The computer program product can include a computer readable storage medium having computer readable program code embodied therewith. The program instructions are executable by a processor. The program instructions are executable by a processor to cause the processor to receive, using the processor, data characterizing a user's environment, wherein the user environment includes location data and activity data. The computer program product can also detect, using the hardware processor, the user's wearable devices that are present on the user. The computer program product can further analyze, using the hardware processor, a user's predicted further activities with respect to the user's wearables for compatibility to the predicted further activities. In some embodiments, the computer program product can recommend, using the hardware processor, one or more wearables to the user based on the analysis.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

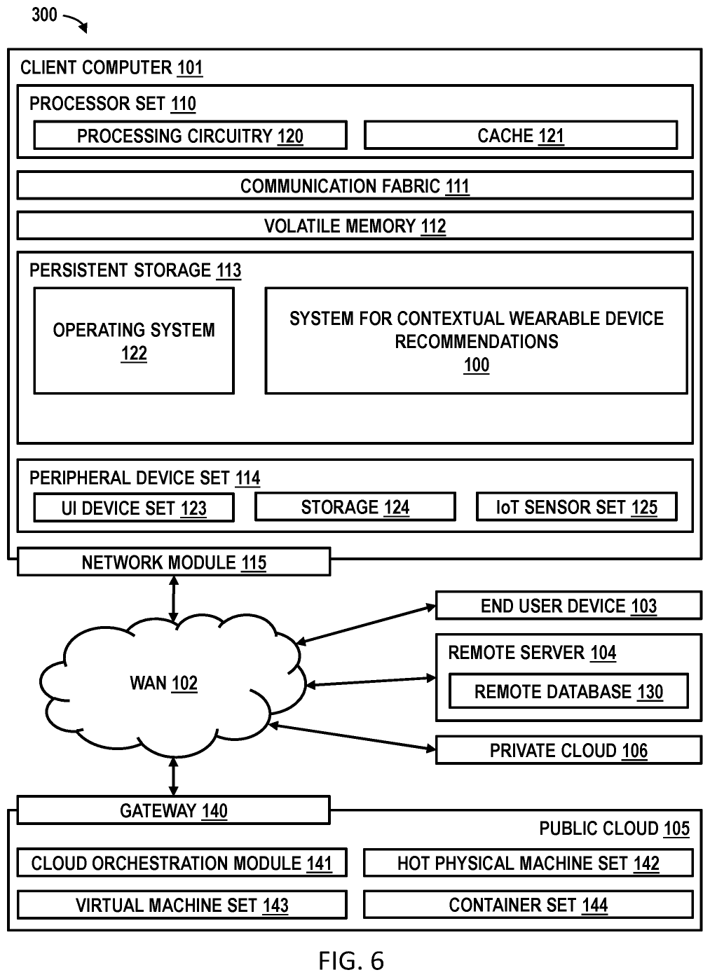

Referring to FIG. 6, the computing environment 300 contains an example of an environment for the execution of at least some of the computer code involved in performing the inventive methods, such as the method for critical path optimization 200. In addition to block 200, computing environment 300 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI), device set 523, storage 524, and Internet of Things (IOT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 300, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 101 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 101 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments,

EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for computer implemented methods for wearable device recommendations (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer implemented method for artificial intelligence (AI) to generate contextual wearable device recommendations to a user comprising:
receiving data, at a computer, characterizing a user's environment, wherein the user environment includes location data;
predicting, with a computer, a user activity from the location data, wherein predicting the user activity comprises artificial intelligence analyzing the location data for comparison with activities from historical activity data for the user;
receiving, at the computer, a list of wearable devices that are present on the user, wherein the user's wearable devices are characterized by sensors for capability;
matching, using the computer, at least one of the wearable devices to the user activity, wherein by employing artificial intelligence the computer wearable devices are matched by capability of their sensor to the user activity; and
sending, using the computer, a recommendation identifying the at least one wearable devices to a user device based on the matching.

2. The computer implemented method of claim 1 further comprising receiving at the computer registration data from the user, wherein the registration data includes user identity and a list of wearable devices for the user.

3. The computer implemented method of claim 1, wherein the at least one wearable devices are selected from the group consisting of smart watches, fitness trackers, electrocardiogram (ECG), blood pressure monitors, and combinations thereof.

4. The computer implemented method of claim 1, wherein the predicting, with a computer, a user activity from the location data.

5. The computer implemented method of claim 1, wherein the predicting user activity based upon observed historical activity data includes at least one of regression clustering and K-nearest neighbor analysis.

6. The computer implemented method of claim 1, wherein characterizing the user's environment comprises location data provided from the at least one wearable devices being analyzed with mapping software.

7. The computer implemented method of claim 1 further comprising configuring with the computer the at least one wearable device to function in the user activity.

8. A system for artificial intelligence (AI) to generate contextual wearable device recommendations to a user comprising:
a hardware processor; and
a memory that stores a computer program product, the computer program product when executed by the hardware processor, causes the hardware processor to:
receive data characterizing a user's environment, wherein the user environment includes location data;
predict user activity from the location data, wherein predicting the user activity comprises artificial intelligence analyzing the location data for comparison with activities from historical activity data for the user;
receive a list of wearable devices that are present on the user, wherein the user's wearable devices are characterized by sensors for capability;
match at least one of the wearable devices to the user activity, wherein by employing artificial intelligence the computer wearable devices are matched by capability of their sensor to the user activity; and
send a recommendation identifying the at least one wearable devices to the user based on the matching.

9. The system of claim 8 further comprising to receive registration data from the user, wherein the registration data includes user identity and a list of wearable devices for the user.

10. The system of claim 8, wherein the at least one wearable devices are selected from the group consisting of smart watches, fitness trackers, electrocardiogram (ECG), blood pressure monitors, and combinations thereof.

11. The system of claim 8, wherein the predicting, with a computer, a user activity from the location data.

12. The system of claim 8, wherein the predicting user activity based upon observed historical activity data includes at least one of regression clustering and K-nearest neighbor analysis.

13. The system of claim 8, wherein characterizing the user's environment comprises location data provided from the at least one wearable devices being analyzed with mapping software.

14. The system of claim 8 further comprising to configure the at least one wearable device to function in the user activity.

15. A computer program product for generating contextual wearable device recommendations to a user, the computer program product can include a computer readable storage medium having computer readable program code embodied therewith, the program instructions executable by a processor to cause the processor to:
receive, using the hardware processor, data characterizing a user's environment, wherein the user environment includes location data;
predict, using the hardware processor, user activity from the location data, wherein predicting the user activity comprises artificial intelligence analyzing the location data for comparison with activities from historical activity data for the user;
receive, using the hardware processor, a list of wearable devices that are present on the user, wherein the user's wearable devices are characterized by sensors for capability;
match, using the hardware processor, at least one of the wearable devices to the user activity, wherein by employing artificial intelligence the computer wearable devices are matched by capability of their sensor to the user activity; and
send, using the hardware processor, a recommendation identifying the at least one wearable devices to the user based on the matching.

16. The computer program product of claim 15 further comprising to receive registration data from the user, wherein the registration data includes user identity and a list of wearable devices for the user.

17. The computer program product of claim 15, wherein the at least one wearable devices are selected from the group consisting of smart watches, fitness trackers, electrocardiogram (ECG), blood pressure monitors, and combinations thereof.

18. The computer program product of claim 15, wherein the predicting, with a computer, a user activity from the location data.

19. The computer program product of claim 15, wherein the predicting user activity based upon observed historical activity data includes at least one of regression clustering and K-nearest neighbor analysis.

20. The computer program product of claim 15 further comprising to configure the at least one wearable device to function in the user activity.
